(19) United States
(12) Patent Application Publication
(10) Pub. No.: US 2015/0149665 A1
(43) Pub. Date: May 28, 2015

(54) POLLING METHOD OF COMMUNICATION SYSTEM

(71) Applicant: LSIS CO., LTD., Anyang-si (KR)

(72) Inventor: KMM KI PAEK, Cheongju-si (KR)

(73) Assignee: LSIS CO., LTD., Anyang-si (KR)

(21) Appl. No.: 14/521,147

(22) Filed: Oct. 22, 2014

(30) Foreign Application Priority Data
Nov. 26, 2013 (KR) 10-2013-0144215

(51) Int. Cl. G06F 13/22

(52) U.S. Cl. CPC G06F 13/225
USPC 710/44

(57) ABSTRACT

The present disclosure relates to a polling method of communication system configured to reduce a polling time by receiving responses from a plurality of auxiliary devices using one time of response request signal by a main device during polling, the method including, requesting, by a main device, transmission of response request signals from a plurality of auxiliary devices connected to the main device (request step),
determining whether each of the plurality of auxiliary devices is a response object after receiving the response request signal (response object determination step),
determining a response order by each of the plurality of auxiliary devices that has determined itself as the response object (response order determination step), and
responding, by itself, to the response request after lapse of waiting time in response to its response order (response step).

Pursuant to 35 U.S.C.§119 (a), this application claims the benefit of earlier filing date and right of priority to Korean Patent Application No. 10-2013-0144215, filed on Nov. 26, 2013, the contents of which are hereby incorporated by reference in their entirety.

### BACKGROUND OF THE DISCLOSURE

1. Field

The teachings in accordance with the exemplary embodiments of this present disclosure generally relate to a polling method of communication system, and more particularly to a polling method of communication system configured to reduce a polling time by receiving responses from a plurality of auxiliary devices using one time of response request signal during polling.

2. Background

Polling is an act of sequentially transmitting, by a main device (master), questions of the monitored objects, i.e., identification (ID) numbers and data of a plurality of auxiliary devices (terminals) desired by the main device to communicate with, and receiving the data from each of the auxiliary devices.

Referring to FIG. 1, a conventional polling method in a communication system is such that, in order for a main device (11) to receive a response from a plurality of auxiliary devices (12) connected to the main device (11), the main device (11) requests a response (question) from each of the auxiliary devices (12-1, 12-2, . . . 12-n), each having an intrinsic ID number, and each of the auxiliary devices (12-1, 12-2, . . . 12-n) transmits the response to main device (11) when each of the auxiliary devices (12-1, 12-2, . . . 12-n) receives the request from the main device (11).

Thus, the main device (11) must transmit request signals as many as the number of relevant auxiliary devices in order for the main device (11) to receive responses from all the auxiliary devices (12) connected thereto. In other words, when there is ‘n’ number of auxiliary devices (12), the main device (11) must transmit n times of request signals including ID numbers, and receive the response from each of the auxiliary devices.

Furthermore, because several devices cannot simultaneously transmit and receive data using a communication line in the course of polling in a communication system, the main device (11) cannot continuously transmit request signals to auxiliary devices (12) and must receive a response from one auxiliary device (12), and then transmit a request signal to a next auxiliary device (12), which disadvantageously takes lots of time for the main device (11) to receive the responses from all the auxiliary devices.

### SUMMARY OF THE DISCLOSURE

The present disclosure is provided to solve the aforementioned conventional problems and the present disclosure provides a polling method of communication system configured to reduce a polling time by receiving responses from a plurality of auxiliary devices using one time of response request signal from a main device during polling act.

In one general aspect of the present disclosure, there is provided a polling method of communication system, the method comprising:

requesting, by a main device, transmission of response request signals from a plurality of auxiliary devices connected to the main device (request step);

determining whether each of the plurality of auxiliary devices is a response object after receiving the response request signal (response object determination step);

determining a response order by each of the plurality of auxiliary devices that has determined itself as the response object (response order determination step); and

responding, by response object auxiliary devices, to the response request after lapse of waiting time in response to its response order (response step).

Preferably, but not necessarily, the response request signal may include a polling method designation area configured to designate a sequential polling method or a polling designation method, a response order designation area configured to a response orders of the plurality of auxiliary devices in response to a polling method designated on the polling method designation area, a setting time area configured to set a response time interval, and a command content area configured to store a command content.

Preferably, but not necessarily, a start number and an end number may be stored in the response order designation area, when the main device and the plurality of auxiliary devices exchange communication in response to the sequential polling method.

Preferably, but not necessarily, the response object determination step may include determining, by the plurality of auxiliary devices, whether the start number, the end number and a number existing between the start number and the end number correspond to its own intrinsic number.

Preferably, but not necessarily, the response order determination step may include determining their own response order by determining, by the auxiliary devices having determined that themselves are response objects among the plurality of auxiliary devices, on which number their own intrinsic number is positioned from the start number.

Preferably, but not necessarily, the response order designation area may be stored with intrinsic numbers of the auxiliary devices desired to receive a response, when the main device and the plurality of auxiliary devices exchange communications in response to the designation polling method.

Preferably, but not necessarily, the response object determination step may include determining, by the plurality of auxiliary devices, whether the intrinsic number stored in the response order designation area corresponds to their own intrinsic number.

Preferably, but not necessarily, the response order determination step may include determining their own response order by determining, by the auxiliary devices having determined that themselves are response objects among the plurality of auxiliary devices, on which position their own intrinsic number is situated among the intrinsic numbers stored in the response order designation area.

Preferably, but not necessarily, the response step may include responding, by the auxiliary devices having determined own response orders, to the response after lapse of time in which own order is multiplied by a setting time.

Preferably, but not necessarily, the response object determination step may include waiting for a next response request signal by the auxiliary devices having determined that they are not the response objects among the plurality of auxiliary devices.

In another general aspect of the present disclosure, there is provided a polling method of communication system, the method comprising:

receiving, by a plurality of auxiliary devices, a sequential polling response request signal, and determining whether they themselves are response objects (response object determination step);

determining, by a plurality of auxiliary devices having determined that they themselves are response objects, and responding after lapse of waiting time in response to the their own response orders (response step);

determining, by a main device, whether responses have been received from all response receipt-desired auxiliary devices, and transmitting designation polling response request signals when the main device have failed to receive the response (re-request step);

receiving, by the plurality of auxiliary devices, the designation polling response request signals transmitted from the main device, and determining whether they themselves are response objects (re-response object determination step); and

determining, by the auxiliary devices having determined that they themselves are re-response objects among the plurality of auxiliary devices, and responding after lapse of waiting time in response to the own response orders (re-response step).

Preferably, but not necessarily, the sequential polling response request signal may allow the auxiliary devices having continuous intrinsic numbers within a predetermined scope among the plurality of auxiliary devices to sequentially respond, and the designation polling response request signal may allow the auxiliary devices having arbitrarily order-designated intrinsic numbers to sequentially respond in response to designated order.

Preferably, but not necessarily, the response object determination step may include checking, by the plurality of auxiliary devices, a start number and an end number included in the sequential polling response request signal, and determining whether their own intrinsic number corresponds to a start number, an end number and a number existing between the start number and the end number.

Preferably, but not necessarily, the response step may include determining, by the auxiliary devices having determined that they themselves are response objects, on which number their intrinsic number is situated from the start number, and responding after lapse of a time in which their response order is multiplied by a setting time included in the sequential polling response request signal.

Preferably, but not necessarily, the re-response object determination step may include determining, by the plurality of auxiliary devices, whether an intrinsic number stored in an order designation area of the designation polling response request signal corresponds to their own intrinsic number.

Preferably, but not necessarily, the re-response step may include determining, by the auxiliary devices having determined that they are re-response objects, on which position the auxiliary devices are situated from the order designation area, and

responding after lapse of a time in which their response order is multiplied by a setting time included in the designation polling response request signal.

### Advantageous Effects of the Disclosure

The polling method of communication system according to the exemplary embodiment of the present disclosure has an advantageous effect in that a polling time can be reduced by receiving, by a main device, responses from a plurality of auxiliary devices by transmitting one time of response request signal during polling.

Another advantageous effect is that a main device can determine a response order of the auxiliary devices, whereby the main device can designate a relevant auxiliary device and receive a fast response if necessary, when the main device desires to receive a fast response from the auxiliary device.

### BRIEF DESCRIPTION OF DRAWINGS

FIG. 1 is an exemplary view illustrating a polling method of communication system according to prior art.

FIG. 2 is a block diagram illustrating a communication system according to an exemplary embodiment of the present disclosure.

FIG. 3 is a flow chart illustrating a polling method in a communication system according to an exemplary embodiment of the present disclosure.

FIG. 4 is a block diagram illustrating a response request signal transmitted by a main device in a communication system according to an exemplary embodiment of the present disclosure.

FIG. 5 is an exemplary view illustrating a sequential polling method in a polling method in a communication system according to an exemplary embodiment of the present disclosure.

FIG. 6 is a flow chart illustrating a sequential polling method in a communication system according to an exemplary embodiment of the present disclosure.

FIG. 7 is a block diagram illustrating a response request signal transmitted by a main device during sequential polling in a communication system according to an exemplary embodiment of the present disclosure.

FIG. 8 is an exemplary view illustrating a designation polling method in a polling method of communication system according to an exemplary embodiment of the present disclosure.

FIG. 9 is a flow chart illustrating a designation polling method in a communication system according to an exemplary embodiment of the present disclosure.

FIG. 10 is a block diagram illustrating a response request signal transmitted by a main device during designation polling in a communication system according to an exemplary embodiment of the present disclosure.

FIG. 11 is a flow chart illustrating a communication method using a sequential polling method and a designation polling method in a communication system according to an exemplary embodiment of the present disclosure.

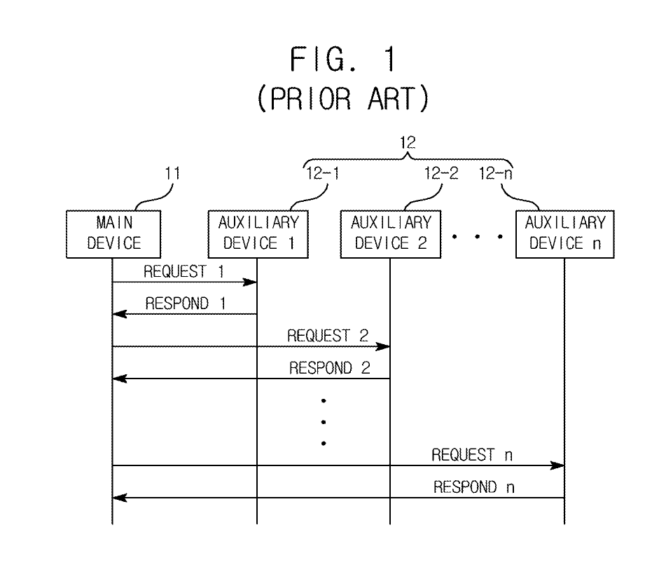

### DETAILED DESCRIPTION OF THE DISCLOSURE

Features and advantages of the exemplary embodiments will be or will become apparent to one of ordinary skill in the art upon examination of the following figures and detailed description. In describing the present disclosure, certain layers, sizes, shapes, components or features may be exaggerated for clarity and convenience. Accordingly, the meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification.

Hereinafter, exemplary embodiments of the present disclosure will be described in detail with reference to the accompanying drawings.

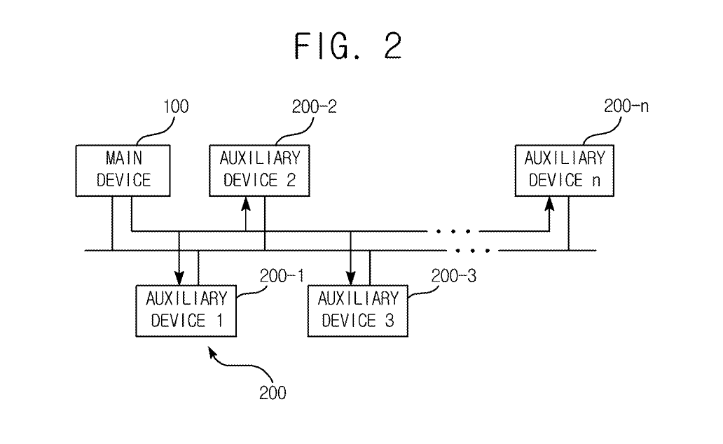

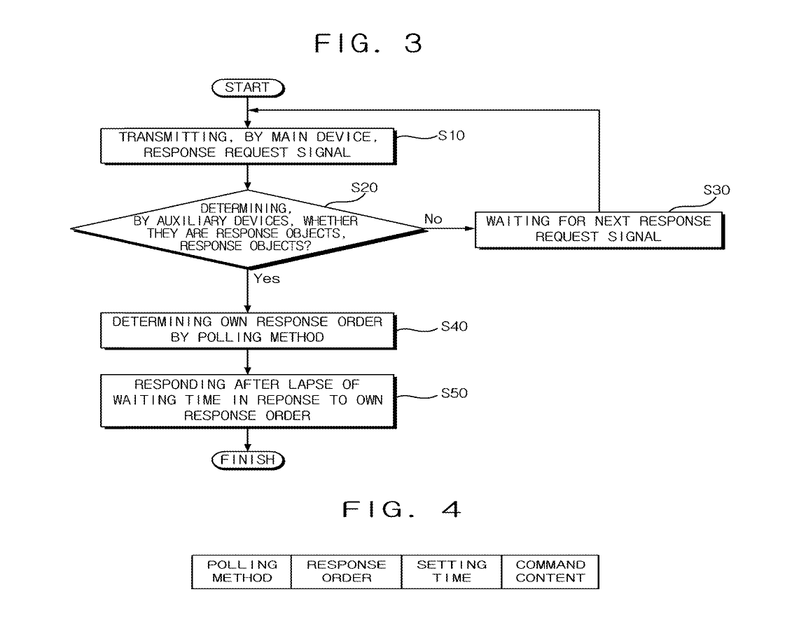

FIG. 2 is a block diagram illustrating a communication system according to an exemplary embodiment of the present disclosure, FIG. 3 is a flow chart illustrating a polling method in a communication system according to an exemplary embodiment of the present disclosure, and FIG. 4 is a block diagram illustrating a response request signal transmitted by a main device in a communication system according to an exemplary embodiment of the present disclosure.

Referring to FIGS. 2 to 4, a main device (100) transmit a response request signal to receive a response from a plurality of auxiliary devices (200) connected to the main device (100) (S10).

Meantime, as illustrated in FIG. 4, the response request signal may include a polling method designation area, a response order designation area, a setting time area and a command content area. The ‘polling method designation area’ is an area where a polling method is stored, the ‘response order designation area’ is an area where a response order is stored, the ‘setting time area’ is an area where a setting time is stored, and the ‘command content area’ is an area where a command content is stored.

At this time, the polling method determines whether responses of the auxiliary devices are sequentially realized or realized in response to a designation order. That is, the polling method determines whether the auxiliary devices (200) respond in a sequential polling method or in a designation polling method. At this time, the response order designation area may be stored with intrinsic numbers of the auxiliary devices according to a response order. The setting time determines response time intervals of the auxiliary devices (200), where the auxiliary devices (200) respond after lapse of time (‘waiting time’) determined by the response order and the setting time. The waiting time may be determined by multiplying each response order of the auxiliary devices by the setting time. The command content is a content desired by the main device (100) to receive from the auxiliary devices (200) and may a ‘transmit an operation state’, for example. The auxiliary devices (200) having received the response request signal including the abovementioned command content may grasp the relevant command content and transmit their operation state.

Meantime, the auxiliary device (200) determines whether the response order include itself when receiving the response request signal transmitted from the main device (100). That is, the auxiliary device (200) determines whether the auxiliary device itself is the response object (S20). At this time, the response request signal transmitted from the main device (100) may be received by all the auxiliary devices (200), where the auxiliary devices (200) check if the response order designation area includes their own intrinsic numbers and determine if they are response objects.

When the auxiliary devices (200) receive the response request signal and determine that the response order area does not include themselves (i.e., when the auxiliary devices (200) are not the response objects), the auxiliary devices (200) wait until a next response request signal is transmitted (S30). Meanwhile, when the auxiliary devices (200) receive the response request signal and determine that the response order area includes themselves (i.e., when the auxiliary devices (200) are the response objects), the auxiliary devices (200) determine the polling method and their own response orders according to the polling method (S40), and respond in response to content described in the command content after lapse of time (‘waiting time’) in which their own response order is multiplied by a time described in the setting time (S50).

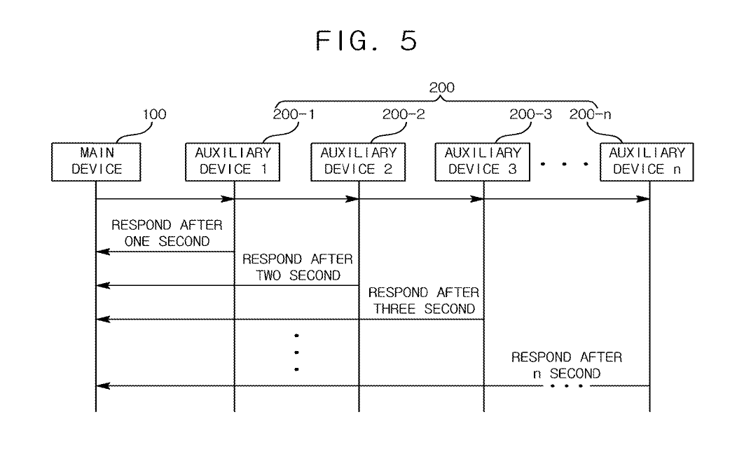

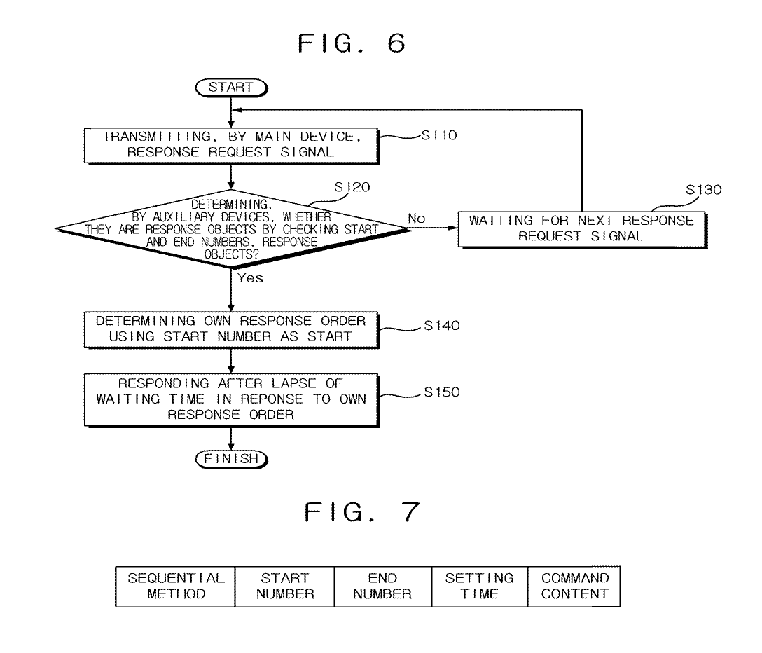

FIG. 5 is an exemplary view illustrating a sequential polling method in a polling method in a communication system according to an exemplary embodiment of the present disclosure, FIG. 6 is a flow chart illustrating a sequential polling method in a communication system according to an exemplary embodiment of the present disclosure, and FIG. 7 is a block diagram illustrating a response request signal transmitted by a main device during sequential polling in a communication system according to an exemplary embodiment of the present disclosure.

Referring to FIGS. 5 to 7 and along with FIG. 2, a sequential polling method of communication system according to an exemplary embodiment of the present disclosure will be described.

First, the main device (100) transmits a response request signal in order to receive a response from the plurality of auxiliary devices (200) connected to the main device (100) (S110). Meantime, as described in FIG. 7, the response request signal during the sequential polling may include a sequential polling designation area, a start number designation area, an end number designation area, a setting time area and a command content area.

In comparison with FIG. 4, data is stored in the polling method designation area of FIG. 4 in order to indicate the sequential polling, the response order designation area of FIG. 4 is stored with a start number and an end number, each being divided, and the setting time area and command content area of FIG. 7 are same as the setting time area and the command content area of FIG. 4, such that no further explanation thereto is elaborated.

At this time, the start number designation area is stored with an intrinsic number of an auxiliary device to first transmit a response as a the end number designation area, and the end number designation area is stored with an intrinsic number of an auxiliary device to lastly transmit a response as an end number. Thus, the response order designation area of FIG. 4 is formed by including the start number designation area and the end number designation area of FIG. 7, and the response order of the auxiliary devices to transmit a response during the sequential polling is determined by the start number stored in the start number designation area and the end number stored in the end number designation area. Thus, an auxiliary device having an intrinsic number included in a predetermined scope among the plurality of auxiliary devices responds in response to the response request signal during the sequential polling. The auxiliary devices (200) determine whether they are included in the response order designation area when the auxiliary devices (200) receive the response request signal as illustrated in FIG. 7.

That is, the auxiliary devices (200) checks the start number and the end number and determines whether the start number, the end number and a number between the start number and the end number correspond to their intrinsic numbers (S120). The auxiliary devices (200) having determined that there are no intrinsic numbers wait until a next response request signal is transmitted (S130). Meantime, the auxiliary devices determine their orders when they have determined that there are included with their intrinsic numbers (S140).

At this time, an auxiliary device having a start number stored in the start number designation area as an intrinsic number determines that it is in the first order, and an auxiliary device having a number corresponding to a next number as an intrinsic number determines that it is in the second order, and the remaining auxiliary devices determine their response orders in the same manner as above.

The response order determination ends by determining own response order by the auxiliary devices having end number stored in the end number designation area as intrinsic number.

For example, when start number is ‘1’, and end number is ‘3’, an auxiliary device (200-1) having an intrinsic number as ‘1’ determines that she {i.e., the auxiliary device (200-1)} herself is a first response order, an auxiliary device (200-2) having an intrinsic number as ‘2’ determines that she {i.e., the auxiliary device (200-2)} herself is a second response order, and an auxiliary device (200-3) having an intrinsic number as ‘3’ determines that she {i.e., the auxiliary device (200-3)} herself is a third response order. That is, the auxiliary devices (200-1, 200-2. 200-3) determining that they themselves are response objects determine on which positions their numbers are situated from the start number as start to determine their response orders.

Next, the auxiliary devices (200-1, 200-2. 200-3) having determined that they themselves are response objects respond in response to a command described in a command content after lapse of time in which their orders are multiplied by a setting time (S150).

For example, when a stare number is ‘1’, an end number is ‘3’ and a setting time is ‘one second’, the auxiliary device (200-1) with an intrinsic number of ‘1’ determines that her own order is first order, responds after one second in which her own number of ‘1’ is multiplied by a setting time of ‘one second’, the auxiliary device (200-2) determines that her own order is second order, responds after two seconds in which her own number of ‘2’ is multiplied by a setting time of ‘two seconds’, and the auxiliary device (200-3) with an intrinsic number of ‘3’ determines that her own order is third order, responds after three seconds in which her own number of ‘3’ is multiplied by a setting time of ‘three seconds’.

Thus, the main device (100) can receive a response by simply transmitting a response request signal just one time, starting with an auxiliary device having a number described on a start number as an intrinsic number, and ending with an auxiliary device having a number described on an end number as an intrinsic number.

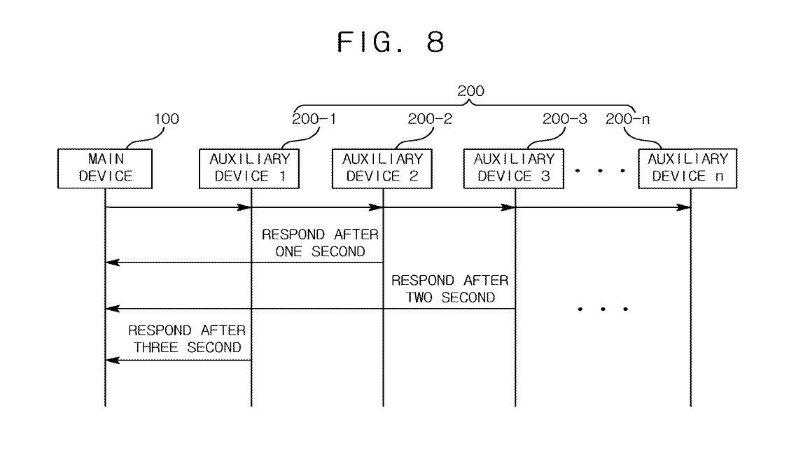

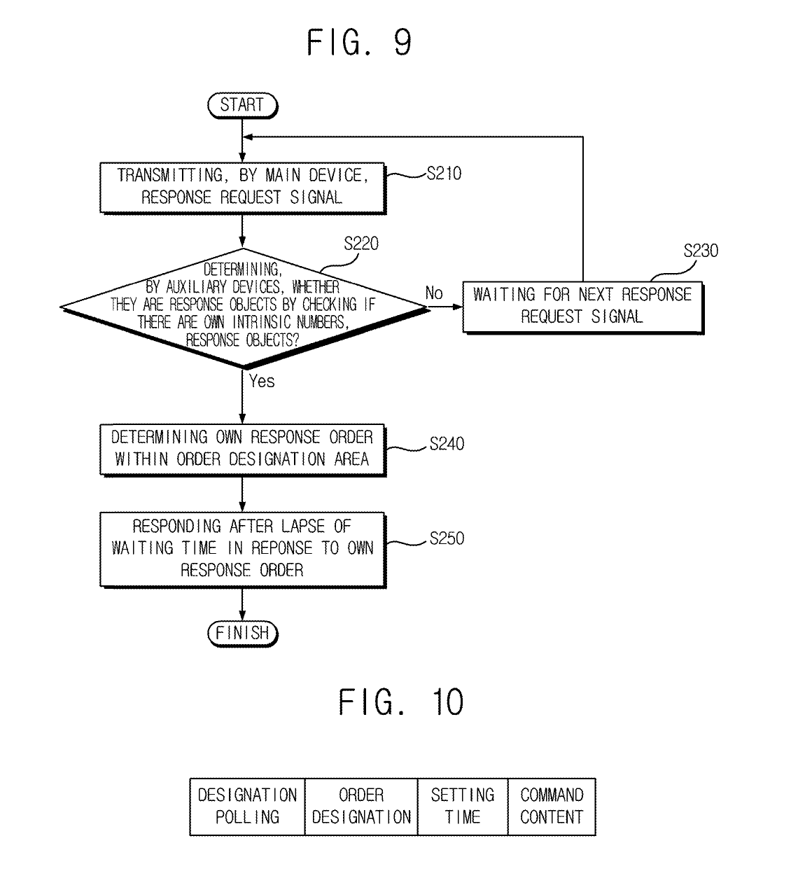

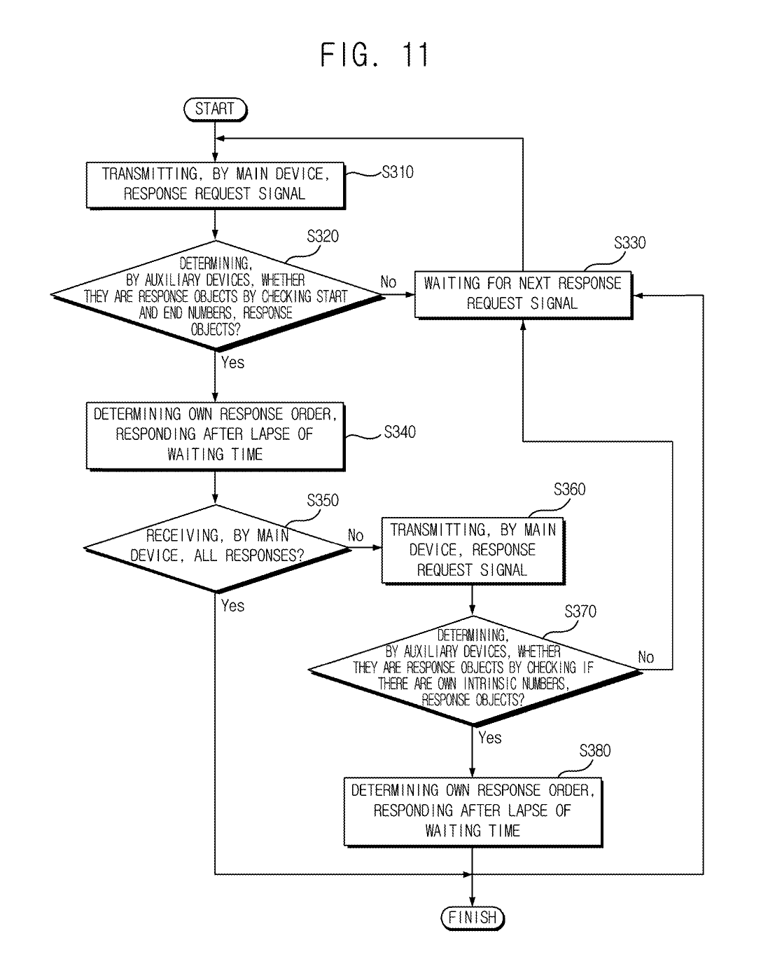

FIG. 8 is an exemplary view illustrating a designation polling method in a polling method of communication system according to an exemplary embodiment of the present disclosure, FIG. 9 is a flow chart illustrating a designation polling method in a communication system according to an exemplary embodiment of the present disclosure, and FIG. 10 is a block diagram illustrating a response request signal transmitted by a main device during designation polling in a communication system according to an exemplary embodiment of the present disclosure.

Referring to FIGS. 8 to 10 along with FIG. 2, a polling method of a communication system according to an exemplary embodiment of the present disclosure will be described.

First, the main device (100) transmits a response request signal in order to receive a response from the plurality of auxiliary devices (200) connected to the main device (100) (S210). Meantime, as described in FIG. 10, the response request signal during the designation polling time may include a designation polling designation area, an order designation area, a setting time and a command content.

In comparison with FIG. 4, data is stored in the polling method designation area of FIG. 4 in order to indicate the designation polling, the response order designation area of FIG. 4 is stored with intrinsic numbers of auxiliary devices that desire to receive responses, and the setting time area and command content area of FIG. 10 are same as the setting time area and the command content storage area of FIG. 4, the details of which are not elaborated thereto.

Thus, the response order designation area of FIG. 4 corresponds to the order designation area of FIG. 10, where the response orders of the auxiliary devices to transmit the responses are determined by orders of intrinsic numbers of auxiliary devices stored in the order designation area. As a result, the response request signal during designation polling is sequentially responded in response to orders designated by the auxiliary devices having arbitrarily order-designated intrinsic numbers.

When the auxiliary devices (200) receive the response request signals as illustrated in FIG. 10, the auxiliary devices (200) determine whether they are in the response order. That is, the auxiliary devices (200) determine whether the numbers stored in the order designation area correspond to their own intrinsic numbers (S220).

The auxiliary devices (200) having determined that there are no intrinsic numbers in the order designation area wait until a next response request signal is transmitted (S230). Meantime, the auxiliary devices determine their orders when they have determined that there are included in the order designation area with their intrinsic numbers (S240).

At this time, the auxiliary devices (200) determine on which positions their own intrinsic numbers are situated in the order designation area based on start of the order designation area.

For example, numbers are designated in the order of 2, 3 and 1 in the order designation area, the auxiliary device (200-2) having an intrinsic number of ‘2’ determines that her own response order is first, the auxiliary device (200-3) having an intrinsic number of ‘3’ determines that her own response order is second, and the auxiliary device (200-1) having an intrinsic number of ‘1’ determines that her own response order is third.

Next, the auxiliary devices (200) having determined their own response orders respond in response to a command described in a command content after lapse of time in which their orders are multiplied by a setting time (S250).

For example, when the order designation area is designated with numbers in the order of 2, 3 and 1, and a setting time is one second, the auxiliary device (200-2) with an intrinsic number of ‘2’ determines that her own order is first order, and responds after one second in which her own order of ‘1’ is multiplied by a setting time of ‘one second’, the auxiliary device (200-2) with an intrinsic number of ‘3’ determines that her own order is second order, and responds after two seconds in which her own order of ‘2’ is multiplied by a setting time of ‘two seconds’, and the auxiliary device (200-3) with an intrinsic number of ‘1’ determines that her own order is third order, and responds after three seconds in which her own order of ‘3’ is multiplied by a setting time of ‘three seconds’.

Thus, the main device (100) can sequentially receive responses by simply transmitting a response request signal just one time, from auxiliary devices corresponding to numbers stored in the order designation area.

Although the foregoing has described and explained a communication between the main device and auxiliary devices using one of the sequential polling method and the designation polling method, a communication method between the main device and the auxiliary devices using both the sequential polling method and the designation polling method will be described and explained hereinafter.

FIG. 11 is a flow chart illustrating a communication method using a sequential polling method and a designation polling method in a communication system according to an exemplary embodiment of the present disclosure.

First, with reference to FIGS. 2 and 11, the main device (100) transmits a response request signal in order to receive a response from the plurality of auxiliary devices (300) connected to the main device (100) (S310). At this time, the main device (100) transmits a response request signal having a configuration as in FIG. 7. That is, the main device (100) communicates with the auxiliary devices (200) in the sequential polling method.

The auxiliary devices (200) having received response request signals as in the configuration of FIG. 7 determine whether their own intrinsic numbers are included in a start number, an end number and a number between the start number and the end number (S320).

The auxiliary devices (200) having determined that there are no intrinsic numbers wait until a next response request signal is transmitted (S330). Meantime, the auxiliary devices (200) having determined that there are no intrinsic numbers determine their orders and respond after lapse of waiting time in response to their own orders (S340).

Order determination and response after lapse of waiting time in response to orders by the auxiliary devices are same as the sequential polling method explained in FIGS. 5 to 7, such that no further elaboration thereto will be made.

Thereafter, the main device (100) determines whether responses have been received from all the auxiliary devices from which responses are to be received (S350). When it is determined that responses have not been received from all the auxiliary devices, the main device (100) transmits response request signals to auxiliary devices from which no responses have been received. At this time, the main device (100) transmits a response request signal having a configuration as illustrated in FIG. 10. That is, the main device (100) communicates with the auxiliary devices (200) in the designation polling method.

The main device (100) having received a response request signal having a configuration as illustrated in FIG. 10 checks if their own intrinsic numbers are in the numbers designated in the order designation area, and determines the response objects (S370). The auxiliary devices (200) having determined that there are no intrinsic numbers in the order designation area wait until a next response request signal is transmitted (S330).

Meantime, the auxiliary devices (200) having determined that there are intrinsic numbers in the order designation area determine their own orders, and respond after lapse of waiting time in response to their own orders (S380).

Order determination and response after lapse of waiting time in response to orders by the auxiliary devices (200) are same as the designation polling method explained in FIGS. 8 to 10, such that no further elaboration thereto will be made.

As apparent from the foregoing, according to the exemplary embodiments of the polling method of communication system in the present disclosure, a time consumed during polling can be reduced by receiving responses from a plurality of auxiliary devices, as a main device transmits one time of response request signal during the polling.

Furthermore, according to the exemplary embodiments of the polling method of communication system in the present disclosure, a main device can determine response orders of the auxiliary devices, whereby the main device can first designate a relevant auxiliary device and receive a fast response if necessary, when the main device desires to receive a fast response from the auxiliary device.

Although the present disclosure has been described in detail with reference to the foregoing embodiments and advantages, many alternatives, modifications, and variations will be apparent to those skilled in the art within the metes and bounds of the claims. Therefore, it should be understood that the above-described embodiments are not limited by any of the details of the foregoing description, unless otherwise specified, but rather should be construed broadly within the scope as defined in the appended claims

What is claimed is:

1. A polling method of communication system, the method comprising:
requesting, by a main device, transmission of response request signals from a plurality of auxiliary devices connected to the main device (request step);
determining whether each of the plurality of auxiliary devices is a response object after receiving the response request signal (response object determination step);
determining a response order by each of the plurality of auxiliary devices that has determined itself as the response object (response order determination step); and
responding, by response object auxiliary devices, to the response request after lapse of waiting time in response to its response order (response step).

2. The polling method of claim 1, wherein the response request signal includes a polling method designation area configured to designate a sequential polling method or a polling designation method, a response order designation area configured to a response orders of the plurality of auxiliary devices in response to a polling method designated on the polling method designation area, a setting time area configured to set a response time interval, and a command content area configured to store a command content.

3. The polling method of claim 2, wherein a start number and an end number are stored in the response order designation area, when the main device and the plurality of auxiliary devices exchange communication in response to the sequential polling method.

4. The polling method of claim 3, wherein the response object determination step includes determining, by the plurality of auxiliary devices, whether the start number, the end number and a number existing between the start number and the end number correspond to its own intrinsic number.

5. The polling method of claim 4, wherein the response order determination step includes determining their own response order by determining, by the auxiliary devices having determined that themselves are response objects among the plurality of auxiliary devices, on which number their own intrinsic number is positioned from the start number.

6. The polling method of claim 2, wherein the response order designation area is stored with intrinsic numbers of the auxiliary devices desired to receive a response, when the main device and the plurality of auxiliary devices exchange communications in response to the designation polling method.

7. The polling method of claim 6, wherein the response object determination step includes determining, by the plurality of auxiliary devices, whether the intrinsic number stored in the response order designation area corresponds to their own intrinsic number.

8. The polling method of claim 7, wherein the response order determination step includes determining their own response order by determining, by the auxiliary devices having determined that themselves are response objects among the plurality of auxiliary devices, on which position their own intrinsic number is situated among the intrinsic numbers stored in the response order designation area.

9. The polling method of claim 8, wherein the response step includes responding, by the auxiliary devices having determined own response orders, to the response after lapse of time in which own order is multiplied by a setting time.

10. The polling method of claim 1, wherein the response object determination step includes waiting for a next response request signal by the auxiliary devices having determined that they are not the response objects among the plurality of auxiliary devices.

11. A polling method of communication system, the method comprising:
receiving, by a plurality of auxiliary devices, a sequential polling response request signal, and determining whether they themselves are response objects (response object determination step);
determining, by a plurality of auxiliary devices having determined that they themselves are response objects, and responding after lapse of waiting time in response to the their own response orders (response step);
determining, by a main device, whether responses have been received from all response receipt-desired auxiliary devices, and transmitting designation polling response request signals when the main device have failed to receive the response (re-request step);
receiving, by the plurality of auxiliary devices, the designation polling response request signals transmitted from the main device, and determining whether they themselves are response objects (re-response object determination step); and
determining, by the auxiliary devices having determined that they themselves are re-response objects among the plurality of auxiliary devices, and responding after lapse of waiting time in response to the own response orders (re-response step).

12. The polling method of claim 11, wherein the sequential polling response request signal allows the auxiliary devices having continuous intrinsic numbers within a predetermined scope among the plurality of auxiliary devices to sequentially respond, and the designation polling response request signal allows the auxiliary devices having arbitrarily order-designated intrinsic numbers to sequentially respond in response to designated order.

13. The polling method of claim 11, wherein the response object determination step includes checking, by the plurality of auxiliary devices, a start number and an end number included in the sequential polling response request signal, and determining whether their own intrinsic number corresponds to a start number, an end number and a number existing between the start number and the end number.

14. The polling method of claim 13, wherein the response step includes determining, by the auxiliary devices having determined that they themselves are response objects, on which number their intrinsic number is situated from the start number, and responding after lapse of a time in which their response order is multiplied by a setting time included in the sequential polling response request signal.

15. The polling method of claim 11, wherein the re-response object determination step includes determining, by the plurality of auxiliary devices, whether an intrinsic number stored in an order designation area of the designation polling response request signal corresponds to their own intrinsic number.

16. The polling method of claim 15, wherein the re-response step includes determining, by the auxiliary devices having determined that they are re-response objects, on which position the auxiliary devices are situated from the order designation area, and
responding after lapse of a time in which their response order is multiplied by a setting time included in the designation polling response request signal.
